(19) United States
(12) Patent Application Publication
(10) Pub. No.: US 2025/0156912 A1
(43) Pub. Date: May 15, 2025

(54) SYSTEM AND PLATFORM FOR REAL-TIME LOADING PERSONALIZED CREATIVE CONTENT ON WEBSITE BY A USER REFERRED BY AN INFLUENCER OR AFFILIATE MARKETER

(71) Applicant: Inflektion Technologies Inc., Victoria (CA)

(72) Inventors: Haafiz Dossa, Victoria (CA); Aron Espino Barbosa, Pasay (PH); Bradley Reid Garner, Courtenay (CA)

(21) Appl. No.: 18/940,996

(22) Filed: Nov. 8, 2024

Related U.S. Application Data
(60) Provisional application No. 63/598,227, filed on Nov. 13, 2023.

(51) Int. Cl. G06Q 30/0282; G06Q 50/00

(52) U.S. Cl. CPC G06Q 30/0282; G06Q 50/01

(57) ABSTRACT

A system is disclosed for rendering for display personalized creative content of an influencer or affiliate marketer on a website of an offer owner in real-time via a web browser on a computer of a user that arrives on the website having been referred by the influencer or affiliate via a Uniform Resource Locator (URL), the system includes one or more servers for executing a method, the method comprising: loading JavaScript onto the website upon arrival of the user to the website via the URL; detecting if the user has arrived at the website by a referral from the influencer or affiliate by extracting an identifier from the URL of the website; if the identifier is associated with the influencer or affiliate, fetching configuration information that is associated with the influencer or affiliate from the one or more servers, wherein the configuration information includes personalized creative content of the influencer or affiliate; processing, on the browser of the user, the configuration information to change content on the website to display the personalized creative content; and displaying the personalized created content via the browser of the user based on the personalized creative content in the configuration information.

### REFERENCE TO RELATED APPLICATIONS

This application claims priority to U.S. provisional application 63/598,227 filed Nov. 13, 2023, entitled “Real-Time Loading Personalized Creative Content on Landing Webpage by user Referred by an Influencer or Affiliate Marketer” which is incorporated by reference herein.

### FIELD OF THE INVENTION

The present invention relates to a system and platform for real-time loading personalized creative content on a webpage by a user referred by an influencer or affiliate marketer.

### BACKGROUND OF THE INVENTION

Many websites such as brand websites typically market products and/or services of a company or an individual. Social media and other influencers or affiliate marketers often promote these products and/or services for sales on those websites. The key measurement of the effectiveness of these marketing campaigns is how well the users (website visitors) end up purchasing the products and services. (This is also referred to as “conversion rate.”) Common techniques to improve the conversion rate include customizing a brand website that is promoted with details about the influencer such as name, photo, quotes, testimonials and/or a description on how the influencer uses the products or services in their daily lives, as well as other marketing creative assets and content that are designed to improve conversion rates by better appealing to the influencer or affiliate's audience. (This is also referred to collectively as “marketing collateral.”)

In order to accomplish this task, the owner of a brand website, for example, must find or obtain marketing collateral from an influencer and then must engage an individual or multiple individuals responsible for making updates to the website to build a custom webpage for that influencer. These steps unfortunately increase costs and time delays to the effort. In addition, because of the increase in costs, smaller or lesser-known influencers and affiliates are often excluded from this process altogether.

It would thus be advantageous to provide improvements to the process described above.

### SUMMARY OF THE INVENTION

A system and platform are disclosed for real-time loading personalized creative content on a website for a user referred by an influencer or affiliate marketer.

In accordance with an embodiment of the present disclosure, a system for rendering for display personalized creative content of an influencer or affiliate marketer on a website of an offer owner in real-time via a web browser on a computer of a user that arrives on the website having been referred by the influencer or affiliate via a Uniform Resource Locator (URL), the system includes one or more servers for executing a method, the method comprising: loading JavaScript onto the website upon arrival of the user to the website via the URL; detecting if the user has arrived at the website by a referral from the influencer or affiliate by extracting an identifier from the URL of the website; if the identifier is associated with the influencer or affiliate, fetching configuration information that is associated with the influencer or affiliate from the one or more servers, wherein the configuration information includes personalized creative content of the influencer or affiliate; processing, on the browser of the user, the configuration information to change content on the website to display the personalized creative content; and displaying the personalized created content via the browser of the user based on the personalized creative content in the configuration information.

In accordance with another embodiment of the disclosure, a method for displaying personalized creative content of an influencer or affiliate on a website of an offer owner in real-time via a web browser on a computer of a user that arrives on a webpage of the offer owner website having been referred by the influencer or affiliate via a Uniform Resource Locator (URL), the method configured to be executed by a system including one or more servers, the method comprising: loading JavaScript onto the webpage of the brand website upon arrival of the user to the website via the URL; detecting if the user has arrived at the webpage of the website by a referral from the influencer or affiliate by extracting an identifier from the URL of the website; if the identifier is associated with the influencer or affiliate, fetching configuration information that is associated with the influencer or affiliate from the one or more servers, wherein the configuration information includes personalized creative content of the influencer or affiliate; processing, on the browser of the user, the configuration information to change content on the website to display the personalized created content, the processing step including adjusting a DOM of the webpage of the website to reflect the personalized creative content and using a MutationObserver that monitors the DOM for both the presence and readiness of target elements, enabling precise timing for manipulation of the DOM to display personalized creative content; and displaying the personalized created content via the browser of the user based on the personalized creative content.

In accordance with another embodiment of the present disclosure, a system for displaying personalized creative content of an influencer on a website of an offer owner in real-time via a web browser on a computer of a user that arrives on the website that is referred by the influencer or affiliate via a Uniform Resource Locator (URL), the system includes one or more servers for executing a method, the method comprising: loading a JavaScript onto the webpage of the brand website upon arrival of the user to the website via the URL; detecting if the user has arrived at the webpage of the website by a referral from the influencer or affiliate by extracting an identifier from the URL of the website; if the identifier is associated with the influencer or affiliate, fetching a configuration file that is associated with the influencer or affiliate from the one or more servers, wherein the configuration file includes personalized creative content of the influencer or affiliate; processing, on the browser of the user, the configuration file to change content on the website to display the personalized created content, the processing step including adjusting a DOM of the website to reflect the personalized creative content; and displaying the personalized created content via the browser of the user based on the personalized creative content.

In accordance with another embodiment of the present disclosure, a method for displaying personalized creative content of an influencer or affiliate on a website of an offer owner in real-time via a web browser on a computer of a user that arrives on a webpage of the offer owner website having been referred by the influencer or affiliate via a Uniform Resource Locator (URL), the method configured to be executed by one or more servers, the method comprising: loading JavaScript onto the website upon arrival of the user to the website via the URL; detecting if the user has arrived at the website by a referral from the influencer or affiliate by extracting an identifier from the URL of the website; if the identifier is associated with the influencer or affiliate, fetching configuration information that is associated with the influencer or affiliate from the one or more servers, wherein the configuration information includes personalized creative content of the influencer or affiliate; processing, on the browser of the user, the configuration information to change content on the website to display the personalized creative content, the processing step including adjusting a DOM of the website to reflect the personalized creative content; and displaying the personalized created content via the browser of the user based on the personalized creative content in the configuration information.

### BRIEF DESCRIPTION OF DRAWINGS

FIGS. 1A-1B depict a block diagram of example process steps of a platform for real-time loading personalized creative content on a webpage of a website by a user that arrives from or referred by an influencer or affiliate marketer.

FIG. 2 depicts a block diagram of example substeps for generating a configuration file for the process shown in FIG. 1A.

FIG. 3 depicts a block diagram of example substeps of processing updates for the process shown in FIG. 1B.

FIG. 4 depicts a diagram illustrating an example system in which a platform for real-time loading personalized creative content on a webpage by a user that is referred by an influencer or affiliate marketer operates.

### DETAILED DESCRIPTION OF THE INVENTION

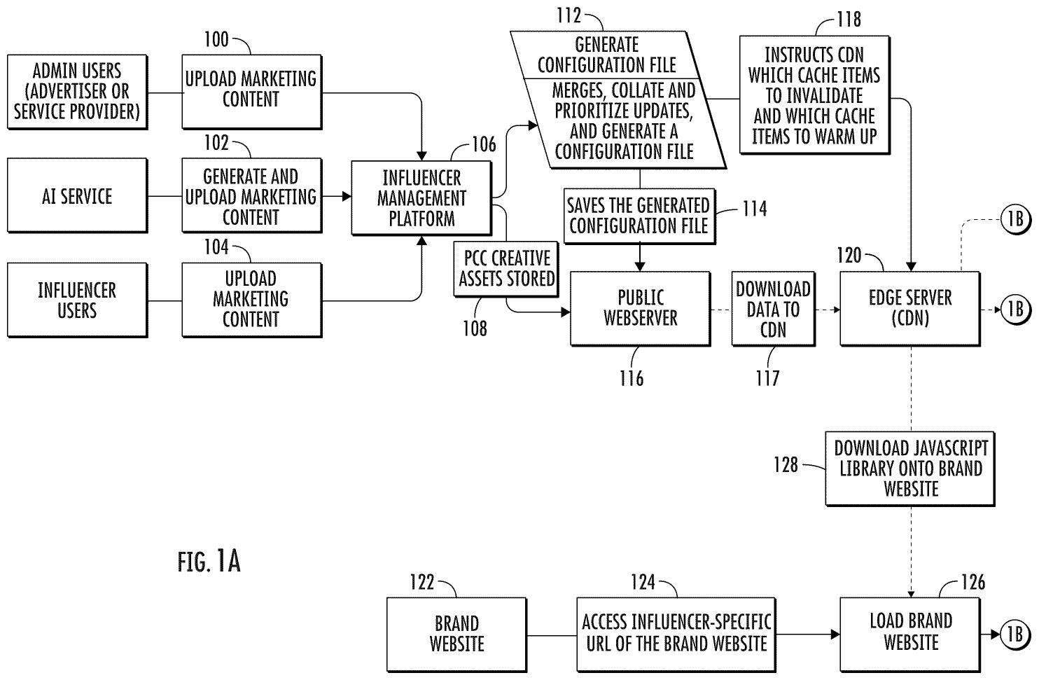

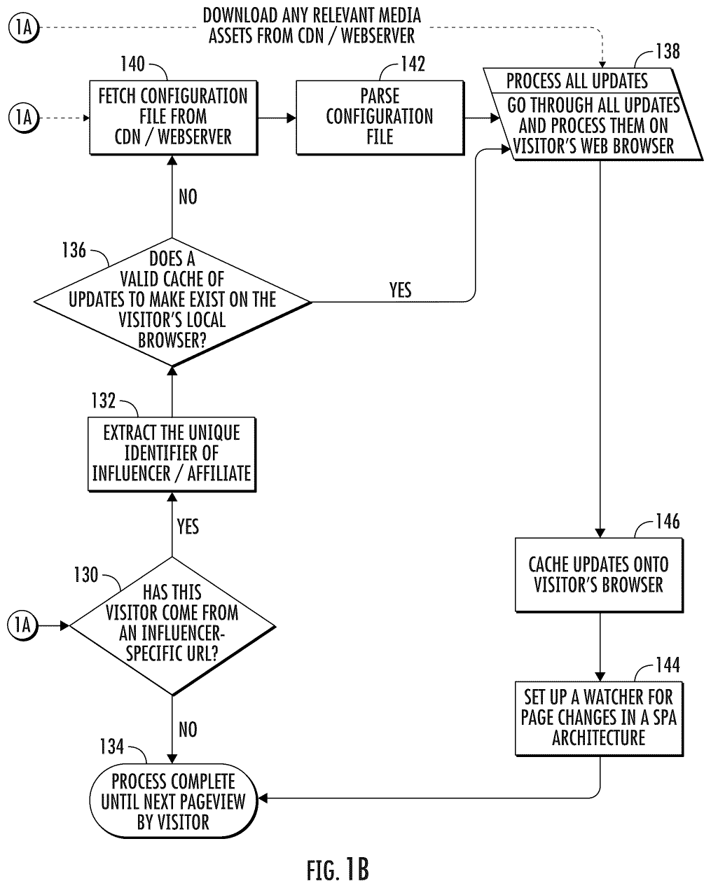

FIGS. 1A-1B depict a block diagram of an example process flow of a platform for real-time loading of personalized creative content on a landing webpage of a website by a user arriving from or referred by an influencer or affiliate/affiliate marketer as described hereinbelow. (This platform is also referred to as an influencer management platform 106 set forth below.) With this platform, the user arrives at the webpage of the website by loading a URL that is associated with the influencer or affiliate marketer and appears on a website such as a social media network. However, the process flow may also apply to a user that arrives at a webpage of a website by loading a URL on an influencer- or affiliate-associated link appearing in an email, application or other medium, or by manually typing by a user.

The website described herein may be a website of a company, brand, affiliate offer, online seller, individual, partnership or other entity known to those skilled in the art that markets products or services or merely provides information to users (known below as an “offer owner”). However, the website shown in FIGS. 1A-1B and described hereinbelow is a website of a brand (or brand website) as an example of an offer owner website. Affiliate or affiliate marketer is an entity or individual having a contractual or transactional relationship with an offer owner (sometimes through an intermediary party) as known to those skilled in the art. An influencer or affiliate referral is typically through a media channel such as a website, email, social media, video feed, podcast, direct mail list or other medium known to those skilled in the art. Influencer and affiliate or affiliate marketer may collectively be referred to herein as “influencer” unless stated otherwise.

Summary. In brief, the platform or method (process) disclosed herein allows the influencer, offer owner, or one of their agencies working with an influencer or affiliate to upload personalized creative content and in real-time, without large effort from the offer owner, display the personalized creative content on the website for users (visitors) directed by the influencer or affiliate. That is, personalized creative content is displayed during or immediately after a webpage of that brand website is loaded so that the original contents of that brand webpage change. The process that adjusts and renders the personalized creative content operates entirely on the user's web browser. Thus, the platform may thus work with any platform or custom ecommerce platforms, avoiding the need to access backend coding to implement the same result.

To achieve the above, the platform incorporates client side JavaScript that executes and detects if a user is an influencer sourced website visitor/user. The JavaScript may be in a library as shown in FIG. 1A and described herein. (Alternatively, other scripting language may be used to achieve desired results.) Then, the platform determines the specific influencer based on an identifier in the URL (Uniform Resource Locator) and promptly fetches encoded configuration information or data that is may be stored as a configuration file, as an example, as shown in FIGS. 1A-1B for that specific influencer sitting on an edge network and then decodes and parses the configuration information to obtain a set of customizations (to make) for the brand webpage and then executes a set of updates on a Document Object Model (DOM) to implement those customizations.

### 1. Configuration File Creation

Referring to FIGS. 1A-1B, the first component or steps of the platform is creating the personalized creative content or collateral (PCC). Participants have the ability to develop PCC. Participants include (1) influencers or affiliates, (2) an internal or third-party team that works for an offer owner, (3) a team that works for company that manages the actual platform described herein and (4) an artificial intelligence (AI) engine (services) running in the background. FIG. 1A depicts these functions at the initial stages of flow as shown.

As shown in FIGS. 1A-1B, administrator (admin) users, influencer users or AI services will upload PCC 100, 102, 104, respectively, to influencer management platform system 106 and the PCC creative assets are stored 108 in publicly-accessible webserver 116.

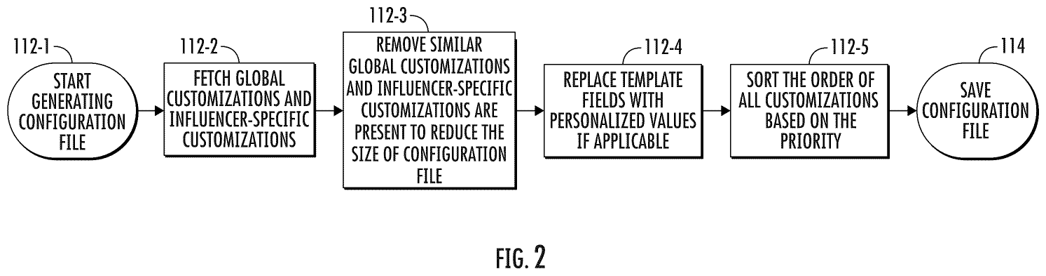

At the same time, a configuration file is generated at 112 and stored in publicly-accessible webserver 116. The combination of all of the PCC changes that need to be made to a page are then merged into a configuration file that contains this set of updates, presorted into the right priority of updates focusing first on the above-the-fold updates (i.e., the updates on the part of the screen first visible to a user once the page loads, necessitating the highest priority of updates). The core substeps for configuration file generation are set forth in FIG. 2.

Referring to FIG. 2, the configuration file generation starts at step 112-1 and proceeds to step 112-2 by fetching global customizations and influencer specific customizations from a database of customizations. This database can either be relational or NoSQL, and ideally has a caching layer in front of it to improve performance. At step 112-3, global customization or any other conflicting customizations that have been overwritten by other influence-specific customizations are removed to reduce the size of the configuration payload in order minimize the number of TCP packets required to transfer the data. Then template fields are replaced with personalized values (if applicable) at step 112-4. All customizations are sorted based on the priority at step 112-5. Then, the configuration information is saved as a file at 114 at the publicly accessible webserver 116. Then, at step 117 the data is downloaded to edge server (CDN-content delivery network) 120 by either having the CDN warm up its cache or upon first access by a user. The configuration file can be a JSON file format or any other proprietary format capable of parsing.

Any PCC assets that are not stored in the configuration file are initially transmitted and stored in a location that can be read by a content delivery network (CDN) server. After that, the configuration file itself is updated (or created if this is a new influencer) in a location that can be read by an edge CDN server 120. If the configuration file or any individual PCC creative assets existed before, then there's an API call to the CDN to invalidate the old configuration file, so the newest assets load right away. This is shown at step 118. Additionally, CDN 120, if supported, is instructed to warm up its caches with the configuration file so the first load in any region is quick.

In sum, now that the configuration file is created, the platform now enables proper loading when a visitor visits the offer owner website via an influencer or affiliate referral. (As described above, an influencer or affiliate referral is typically through a media channel such as a website, email, social media, video feed, podcast, direct mail list or other medium known to those skilled in the art.)

### 2. Real Time-Personalization

When a user/visitor lands on an offer owner website at steps 122, 124, 126 for example, JavaScript in the form of a library as an example is loaded onto that webpage of the brand website at step 128. The JavaScript library will (1) detect that if a user arrives at the brand website by an influencer or affiliate referral and if so, (2) load and (3) process the PCC configuration file described above and then cache the PCC configuration file changes. The JavaScript library that is loaded onto the webpage is configured in a way in which DNS prefetching is performed and pre-connects are utilized in order to optimize speed. The PCC configuration file loading and processing preferably happens in parallel with website loading so as to minimize latency of all changes that the user views.

Detection. A user referred to the offer owner website via an influencer or affiliate is detected using variables in the Uniform Resource Locator (URL), or website cookies or browser localStorage as identifiers if the visitor has previously visited and saved this configuration. That is, the URL that is loaded has uniquely identifiable tracking parameters embedded into it. These identifiers are used to identify if the visitor/user is visiting the website from the referral influencer or affiliate website.

In practice, if user comes from an influencer or affiliate referral at decision step 130, the unique identifier of influencer is extracted at step 132. If the user does not come from an influencer or affiliate referral, the process is complete until next pageview by the visitor/user at 134. At decision step 136, if no valid cache exists of updates, execution proceeds to step 140 (described below). If a valid cache of updates (to be made) exists on the visitor's browser, a background XHR load of the configuration data is started so that a non-blocking update of any configuration data can be obtained, meanwhile in parallel, execution proceeds directly to step 138 (described below).

Configuration File Download. Once the identifier is extracted, the configuration file is fetched from CDN/webserver at step 140 by making an asychronous outbound call to the server storing the PCC configuration file. The configuration file is parsed at step 142 into an instructional set of updates to make and execution proceeds to step 138.

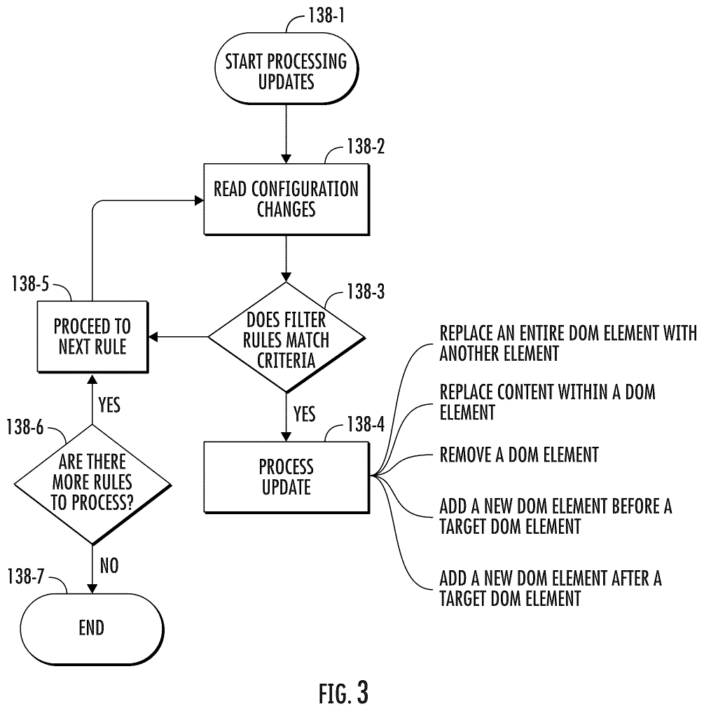

Processing of PCC Changes. The on-page JavaScript library then processes each of the changes in the configuration file at step 138 on the visitor's web browser, in order, and then makes updates to the content on the webpage of the offer owner website by making adjustments to the DOM. Details of the processing step 138 is performed by the substeps in FIG. 3 as described below.

In FIG. 3, processing updates starts at 138-1 and proceeds to step 138-2 wherein configuration changes are read. Execution proceeds to decision step 138-3 wherein it is determined if the filter rules match criteria. That is, before executing each change, the JavaScript library also processes if there any filters for any of the updates (e.g., to make certain updates on certain pages only or any other conditions that are specified in the configuration file) so not all rules may execute. If the filter rules match, execution then proceeds to step 138-4 wherein the updates are processed. The types of updates that can be run by the processor here are (1) replacing entire DOM element with another element, (2) replacing content within a DOM element, (3) removing a DOM element, (4) adding a new DOM element before a target DOM element and (5) adding a new DOM element after a target DOM element.

For the DOM updates described hereinabove, the platform or method uses a MutationObserver that monitors the DOM for both the presence and readiness of target elements on the webpage of a website of the offer owner, enabling precise timing for manipulation and preventing content flicker or delayed rendering. This observer-based approach ensures that DOM manipulations are executed as the target elements are fully loaded and structurally stable, enhancing both UX and performance metrics. Additionally, for updates to DOM elements above the fold (i.e., viewable by the user before any scrolling is needed), the platform or method uses an algorithm to detect and hide, and then unhide, certain elements on the webpage in order to enhance both UX and reduce Cumulative Layout Shift (an industry term defined around website webpage load speed optimization). If the filter rules do not match the criteria, then execution proceeds to the next rule at step 138-5 and returns to reading further configuration changes 138-2. If there are no more rules at step 138-6, then execution ends at 138-7.

At step 144, the JavaScript library also watches for virtual webpage changes that don't fully reload the page from websites built with a single page application (SPA) architecture. All PCC changes are then cached locally on the visitor's browser at step 146 using persistent storage settings such as browser cookies or localStorage, in order to invalidate the need for detection, configuration file download and processing PCC changes described above for future during a certain duration of time until the cache invalidates. In an example embodiment, to make sure the PCC renders properly for SPA website architectures, the JavaScript library hooks into history and popstate events to capture virtual page transitions. Execution then proceeds back to step 134 wherein the process is complete until the next pageview by a visitor.

The flow above depicts example steps of the platform or method to enable configuration file creation with PCC, referral user identification, configuration file downloading and PCC processing changes to a brand's website (and caching such changes). However, those skilled in the art know that any number of additional steps or lesser number of steps may performed to achieved desired results. For example, according to on the above steps, assets are placed in a CDN (step 116) to optimally expedite a brand webpage with PCC. However, the files may be downloaded straight from a normal webserver to achieve the same results, though there may be an increase in latency for the PCC to be displayed to the end user. Asynchronous nature of the call are preferred but may not be needed. A browser may execute similar steps but not asynchronously so latency may affect PCC display to the end user. Another alternative is to split the configuration file into multiple files. The same result will occur but may be an increase in latency for the PCC to be displayed to the end user. When loading relevant media assets from webserver as shown in FIG. 1B, asset preloading may optionally be employed. When an image asset is reference in personalization settings, the JavaScript triggers a background preload, ensuring that the asset is already cached and available in the user's browser when the personalized creative content is later rendered. This optimizes rendering time and reduces perceived load latency for personalized content. These are just a few examples. Other alternative steps may be used to achieve desired results as known to those skilled in the art.

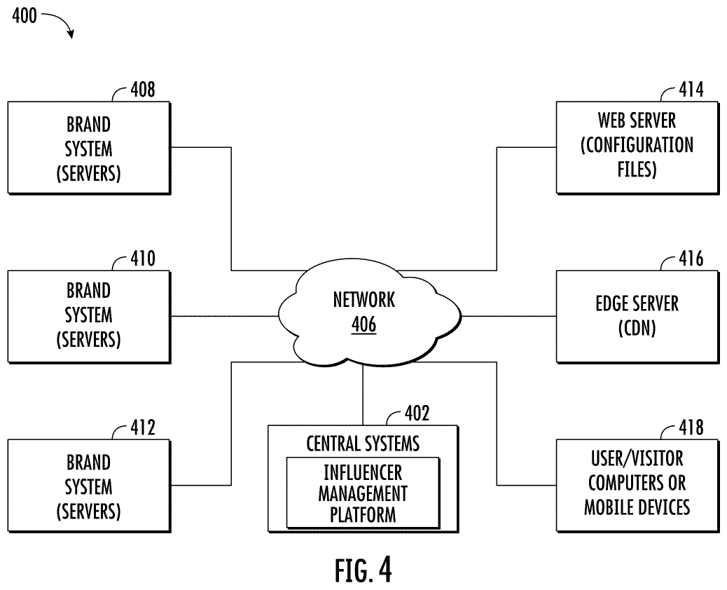

FIG. 4 depicts a diagram illustrating an example system 400 in which a platform for real-time loading personalized creative content on a webpage by a user referred by an influencer or affiliate marketer operates (i.e., influencer management platform 106 as described above).

Specifically, in this example, system 400 incorporates central system 402 as well as brand systems 408, 410, 412 (also known as clients). There are three brand system instances but any number of brand system instances or offer owner system instances could be used, and they act independently of one another. Central system 402 is connected brand systems 408, 410, 412 via network 406. The URL that links to central system 402, and brand systems 408, 410 and 412 may exist on a website, but as described herein, the URL may be in other mediums (e.g., email).

Network 406 may be the Internet, local area network (LAN) or both as known to those skilled in the art. Instances of the brand's computer systems 408, 410, 412 (offer owner systems) may each communicate with central system 402 over network 406 by cable, fiber optic, satellite, DSL, ISDN, WIFI or wireless carrier networks as known to those skilled in the art.

Central system 402 includes one or more servers (among other components) in which influencer management platform 106 described herein operates. Brand systems 408, 410, 412 (offer owner systems) include one more servers (among other components) in which the brand websites are stored for accessing website content.

System 400 also incorporates web server 414, edge server 416 and one or more user/visitor computers or mobile devices 418. Web server 414 is configured to store and deliver website files to users over the Internet as known to those skilled in the art. Also known to those skilled in the art, web server 414 is typically a cloud device and it comprises hardware, software and website content. The hardware includes the computer that stores the website files and software typically includes an HTTP server which communicates with URLs and HTTP protocol used by browsers as known to those skilled in the art. Edge server 416 is part of a computing infrastructure and services that are located closer to the end users who are accessing content to reduce latency, increase speed and manage bandwidth usage more efficiently. Computers or mobile devices 418 are used by the users/visitors that use a browser to access a brand website referred by an influencer or marketer affiliate.

The servers and computers described herein typically includes at least one or more processors, system memory (volatile RAM or non-volatile ROM). System memory may include computer readable media that is accessible to the processor(s). The memory may also include instructions from processor, an operating system and one or more application platforms such as Java and a part of software modules or one or more software applications (i.e., steps) and/or modules. The server or computer will include one or more communication connections such as network interfaces to enable the computer to communicate with other computers over a network, storage such as a hard drives for storing program data The servers may runs Unix or Linux or Microsoft Windows or Macintosh OSX or other as the operating system. Computers may run similar operating systems. A display is optionally used.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A method for displaying personalized creative content of an influencer or affiliate on a website of an offer owner in real-time via a web browser on a computer of a user that arrives on a webpage of the offer owner website having been referred by the influencer or affiliate via a Uniform Resource Locator (URL), the method configured to be executed by a system including one or more servers, the method comprising:
loading JavaScript onto the webpage of the website upon arrival of the user to the webpage of the website via the URL;
detecting if the user has arrived at the webpage of the website by a referral from the influencer or affiliate by extracting an identifier from the URL of the website;
if the identifier is associated with the influencer or affiliate, fetching configuration information that is associated with the influencer or affiliate from the one or more servers, wherein the configuration information includes personalized creative content of the influencer or affiliate;
processing, on the browser of the user, the configuration information to change content on the website to display the personalized created content, the processing step including adjusting a DOM of the webpage of the website to reflect the personalized creative content and using a MutationObserver that monitors the DOM for both the presence and readiness of target elements, enabling precise timing for manipulation of the DOM to display personalized creative content; and
displaying the personalized created content via the browser of the user based on the personalized creative content.

2. The system of claim 1 wherein the method further comprising decoding and parsing the configuration information into updates that need to be made to the website to display the personalized creative content in the configuration information via the browser of the user.

3. A system for rendering for display personalized creative content of an influencer or affiliate marketer on a website of an offer owner in real-time via a web browser on a computer of a user that arrives on the website having been referred by the influencer or affiliate via a Uniform Resource Locator (URL), the system includes one or more servers for executing a method, the method comprising:
loading JavaScript onto the website upon arrival of the user to the website via the URL;
detecting if the user has arrived at the website by a referral from the influencer or affiliate by extracting an identifier from the URL of the website;
if the identifier is associated with the influencer or affiliate, fetching configuration information that is associated with the influencer or affiliate from the one or more servers, wherein the configuration information includes personalized creative content of the influencer or affiliate;
processing, on the browser of the user, the configuration information to change content on the website to display the personalized creative content; and
displaying the personalized created content via the browser of the user based on the personalized creative content in the configuration information.

4. The system of claim 3 wherein the method further comprising decoding and parsing the configuration information into updates that need to be made to the website to display the personalized creative content in the configuration information via the browser of the user.

5. The system of claim 3 wherein the processing step including adjusting a DOM of the website to reflect the personalized creative content.

6. The system of claim 3 wherein the URL is included in a website, email, video, podcast, application, direct mail or user manual type-in.

7. The system of claim 3 wherein the method further includes downloading the JavaScript from the one or more servers for loading it onto the website upon arrival of the user to the website.

8. The system of claim 3 wherein the method further includes receiving the personalized creative content created so as to generate the configuration information with the personalized creative content.

9. The system of claim 3 wherein the configuration information is generated by fetching customizations of the influencer for the personalize creative content and removing similar customizations to reduce a size of the configuration information.

10. The system of claim 9 wherein the configuration information is further generated by replacing template fields with values of the personalized creative content and sorting an order of the customizations based on a priority.

11. The system of claim 3 wherein the offer owner's website is a brand owner's website or an individual's website.

12. A method for displaying personalized creative content of an influencer or affiliate on a website of an offer owner in real-time via a web browser on a computer of a user that arrives on the offer owner website having been referred by the influencer or affiliate via a Uniform Resource Locator (URL), the method configured to be executed by one or more servers, the method comprising:
loading JavaScript onto the website upon arrival of the user to the website via the URL;
detecting if the user has arrived at the website by a referral from the influencer or affiliate by extracting an identifier from the URL of the website;
if the identifier is associated with the influencer or affiliate, fetching configuration information that is associated with the influencer or affiliate from the one or more servers, wherein the configuration information includes personalized creative content of the influencer or affiliate;
processing, on the browser of the user, the configuration information to change content on the website to display the personalized creative content, the processing step including adjusting a DOM of the website to reflect the personalized creative content; and
displaying the personalized created content via the browser of the user based on the personalized creative content in the configuration information.

13. The system of claim 12 wherein the method further comprising parsing the configuration information into updates that need to be made to the brand website to display the personalized creative content in the configuration information via the browser of the user.

14. The system of claim 12 wherein the URL is included in a medium including website, email, application or user manual type.

15. The system of claim 12 wherein the method further includes receiving the personalized creative content created by the influencer, offer owner or agency so as to generate the configuration information with the personalized creative content.

16. The system of claim 12 wherein the method further includes downloading the JavaScript from the one or more servers for loading it onto the brand website upon arrival of the user to the brand website.

17. A system for displaying personalized creative content of an influencer on a website of an offer owner in real-time via a web browser on a computer of a user that arrives on the website that is referred by the influencer or affiliate via a Uniform Resource Locator (URL), the system includes one or more servers for executing a method, the method comprising:
loading JavaScript onto the webpage of the brand website upon arrival of the user to the website via the URL;
detecting if the user has arrived at the webpage of the website by a referral from the influencer or affiliate by extracting an identifier from the URL of the website;
if the identifier is associated with the influencer or affiliate, fetching a configuration file that is associated with the influencer or affiliate from the one or more servers, wherein the configuration file includes personalized creative content of the influencer or affiliate;
processing, on the browser of the user, the configuration file to change content on the website to display the personalized created content, the processing step including adjusting a DOM of the website to reflect the personalized creative content; and
displaying the personalized created content via the browser of the user based on the personalized creative content.

18. The method of claim 17 wherein the personalized creative content is stored in a configuration file configured to be fetched from the one or more servers to make changes that need to be made to the website to display the personalized creative content via the browser of the user.

19. The method of claim 17 further comprising parsing the configuration file into updates that need to be made to the website to display the personalized creative content in the configuration file via the browser of the user.

20. The method of claim 17 wherein the URL is included in a website, email, application or user manual type.

21. The system of claim 17 wherein the method further includes downloading the JavaScript from the one or more servers for loading it onto the website upon arrival of the user to the website.

22. The system of claim 17 wherein the method further includes receiving the personalized creative content created by the influencer so as to generate the configuration file with the personalized creative content.
